(19) United States
(12) Patent Application Publication
(10) Pub. No.: US 2011/0297113 A1
(43) Pub. Date: Dec. 8, 2011

(54) APPARATUS FOR VARIABLY SETTING THE CONTROL TIMES OF GAS EXCHANGE VALVES OF AN INTERNAL COMBUSTION ENGINE, AND SCREWS FOR AN APPARATUS OF THIS TYPE

(75) Inventor: Mario ARNOLD, AURACHTAL (DE)

(73) Assignee: SCHAEFFLER TECHNOLOGIES GMBH & CO. KG

(21) Appl. No.: 13/153,655

(22) Filed: Jun. 6, 2011

(30) Foreign Application Priority Data
Jun. 7, 2010 (DE) 10 2010 022 897.4

(51) Int. Cl. F01L 1/344; F16B 35/00

(52) U.S. Cl. 123/90.15; 411/378

(57) ABSTRACT

An apparatus for variably setting the control times of gas exchange valves of an internal combustion engine which has at least one first screw with a threaded section, an action section for an assembly tool and a fastening section arranged on a side of the action section which faces away from the threaded section and acted on by a spring element. As a result of the first screw, a turning operation is omitted during the mounting of the apparatus, and insertion of the spring element on the screw head side is produced without further connecting points or elements.

### CROSS-REFERENCE TO RELATED APPLICATION

This application claims the priority of DE 10 2010 022 897.4 filed Jun. 7, 2010, which is incorporated by reference herein.

### FIELD OF THE INVENTION

The invention relates to an apparatus for variably setting the control times of gas exchange valves of an internal combustion engine.

### BACKGROUND OF THE INVENTION

In modern internal combustion engines, apparatuses for variably setting the control times of gas exchange valves, also known as camshaft adjusters, are used, in order for it to be possible to configure the phase relation of a camshaft relative to a crankshaft to be variable in a defined angular range, between a maximum early position and a maximum late position. DE 10 2009 041 768, for example, discloses such an apparatus. The cams of the camshafts usually bear against cam followers, for example bucket tappets, drag levers or valve rockers. If a camshaft is set in rotation, the cams roll on the cam followers which in turn actuate the gas exchange valves. Both the opening duration and the opening amplitude, but also the opening and closing instants of the gas exchange valves, are therefore fixed by the position and the shape of the cams.

The angular displacement of the camshaft in relation to the crankshaft in order to achieve optimized control times for various speed and load states is called camshaft adjustment. One structural variant of a camshaft adjuster operates, for example, according to what is known as the swing motor principle. Here, a stator and a rotor are provided which lie coaxially and can be moved relative to one another. The stator and the rotor together form hydraulic chamber pairs. Here, one chamber pair is delimited in each case by webs of the stator and is divided by a respective vane of the rotor into two pressure chambers which act in opposite directions and the volumes of which are modified by a relative rotational movement of the rotor in the opposite direction with respect to the stator. In the maximum adjusting position, the respective vane bears against one of the edge-side webs of the stator. The relative rotational movement of the rotor takes place by an adjustment of the vane, by a hydraulic medium or pressure medium, such as oil, being introduced via pressure medium channels into one of the pressure chambers of the chamber pair and pressing the vane away. The pressure medium channels open on both sides of the respective vane, with the result that the hydraulic medium is guided into the respective pressure chamber. By way of the adjustment of the rotor, the camshaft which is fastened to the rotor is adjusted, for example, in the early direction, that is to say an earlier opening instant of the gas exchange valves. By way of adjustment of the rotor in the opposite direction, the camshaft is adjusted with respect to the crankshaft in the late direction, that is to say a later opening instant of the gas exchange valves.

In the basic position, typically a “late” control time in the case of inlet adjustment and an “early” control time in the case of outlet adjustment, a spring-loaded pin locks the adjuster when the engine is switched off; during operation, this lock is released hydraulically. If used as an outlet camshaft adjuster with end position in the “early” control time, moreover, a restoring spring is provided on the camshaft adjuster, which restoring spring assists the reaching of the locked end position.

A plurality of different screws are usually used in camshaft adjusters. Two covers which delimit the pressure chambers axially are fastened to the camshaft adjuster on the end side by means of the screws. In addition, two of said screws are provided for connecting the restoring spring. The spring is connected as a rule on that side of the camshaft adjuster which faces away from the screw head, with the result that a turning operation is required.

### OBJECT OF THE INVENTION

The invention is based on the object of simplifying the assembly of an apparatus for variably setting the control times of gas exchange valves of an internal combustion engine.

### Achievement of the Object

According to the invention, the object is achieved by an apparatus for variably setting the control times of gas exchange valves of an internal combustion engine comprising a drive element which can be brought into drive connection with the crankshaft of the internal combustion engine, an output element, which can be brought into drive connection with the camshaft of the internal combustion engine, pivotable with respect to the drive element, at least one first screw having a threaded section, an action section engageable by an assembly tool and a fastening section arranged on a side of the action section facing away from the threaded section, at least one front side cover arranged on an axial front side of the drive element or the output element and connected fixedly to the drive element or the output element so as to rotate with the drive element or the output element by means of the first screw, and a spring element arranged ahead of the front side cover and acting on the fastening section of the first screw.

Furthermore, according to the invention, the object is achieved by a screw comprising a threaded section, an action section engageable with an assembly tool. and a fastening section arranged on a side of the action section facing away from the threaded section.

The invention is based on the consideration that particularly simple assembly of the apparatus for variably setting the control times of gas exchange valves of an internal combustion engine, furthermore called a camshaft adjuster, is ensured by the screws, on which the spring element, also called a restoring spring, is clipped, being screwed in from the side on which the restoring spring is also situated. As a result, it is no longer required during the construction of the camshaft adjuster to ensure access from both axial sides and, in particular, the turning operation is omitted. In addition, the insertion of the restoring spring on the screw head side is produced without further connecting points or elements.

Simplified assembly of this type of the camshaft adjuster is made possible by the special design of the screws for clipping the restoring spring. A screw of this type has three sections: an end-side threaded section for screwing into the drive element or the output element, a central action section which forms an outer drive for an assembly tool, and an end-side fastening section, on which one end of the restoring spring acts. The fastening section is, in particular, of cylindrical configuration. Here, an outer drive of the screws has the advantage that the tool for screwing in the screws is subject to less wear.

On account of the special arrangement of the three sections, the screw can be screwed in on the front side, in particular until contact of the action section against the front side cover. After the production of the screw connection, the fastening section protrudes axially out of the plane of the front side cover and is therefore freely accessible for clipping in the restoring spring without turning the camshaft adjuster, in contrast to a conventional camshaft adjuster, in which the restoring spring is clipped in after an additional turning operation.

At least one second screw which has merely a threaded section and an action section is preferably provided for fastening the front side cover. At least the action section and, in particular, also the threaded section are identical to the action section of the first screw. The second screw therefore differs from the first screw merely in that no fastening section is provided. The screw is used only for screwing on at least the front side cover and is not suitable for clipping in the restoring spring. On account of the identical construction of the screw drive of the first and the second screws, no tool change is required during the mounting of the screws.

According to one preferred embodiment, the fastening section is configured in one piece with the action section. This embodiment is distinguished by its high strength, since the fastening section, the action section and the threaded section form a single-piece screw which is manufactured in only one production step.

According to an alternative preferred embodiment, the fastening section is configured separately from the action section and is fastened to the latter. It is possible here to use homogeneous screws which have only a threaded section and an action section for fastening at least the front side cover. Two of said screws are subsequently complemented by a fastening section, in order to clip in the restoring spring. The same screws can therefore be used both in an inlet camshaft adjuster and in an outlet camshaft adjuster, two screws of the outlet camshaft adjuster being modified for clipping in the restoring spring by a fastening section being fastened to the action section.

Easy access to the screw drive is ensured, even if there is a projecting fastening section, by the action section preferably protruding beyond the fastening section in the radial direction of the screw. A suitable wrench or socket wrench insert with an inner drive can therefore engage around the action section without problems, even if the latter is arranged axially behind a fastening section. In order that the fastening section does not impede the access to the action section, a depth of the inner drive of the assembly tool is selected in such a way that both the fastening section and the action section can be received in the inner drive. As an alternative, the assembly tool has an, in particular, cylindrical depression on the base of the inner drive, which depression is provided for receiving the fastening section.

The action section is expediently of star-shaped configuration. In particular, outer square drives, outer hexalobe drives or outer hexagonal drives which are used widely nowadays are suitable as action section.

According to one preferred variant, a rear side cover which is arranged on the rear side of the camshaft adjuster is configured in one piece with the drive element. The drive element, in this case the stator, is therefore of cup-shaped configuration. In this case, the necessity is dispensed with of fastening the rear side cover by way of the screws to the camshaft adjuster.

The threaded section is advantageously approximately 18 mm long. Here, the length of the threaded section is adapted to the minimum width of a commercially available rotor. If the rear side cover is configured in one piece with the stator, screws of a length can be used without problems which are smaller than the width of the rotor, since the screws are provided merely for fastening the front side cover and do not necessarily have to extend to the rear side cover. The use of screws with a length of the threaded section of 18 mm is therefore independent of the axial overall width of the camshaft adjuster.

### BRIEF DESCRIPTION OF THE DRAWING

One exemplary embodiment of the invention will be explained in greater detail using a drawing, in which:

FIG. 1 shows a section in the radial direction through a camshaft adjuster, and

FIG. 2 shows a section in the axial direction through a camshaft adjuster.

Identical designations have the same meaning in the different figures.

### DETAILED DESCRIPTION OF THE DRAWING

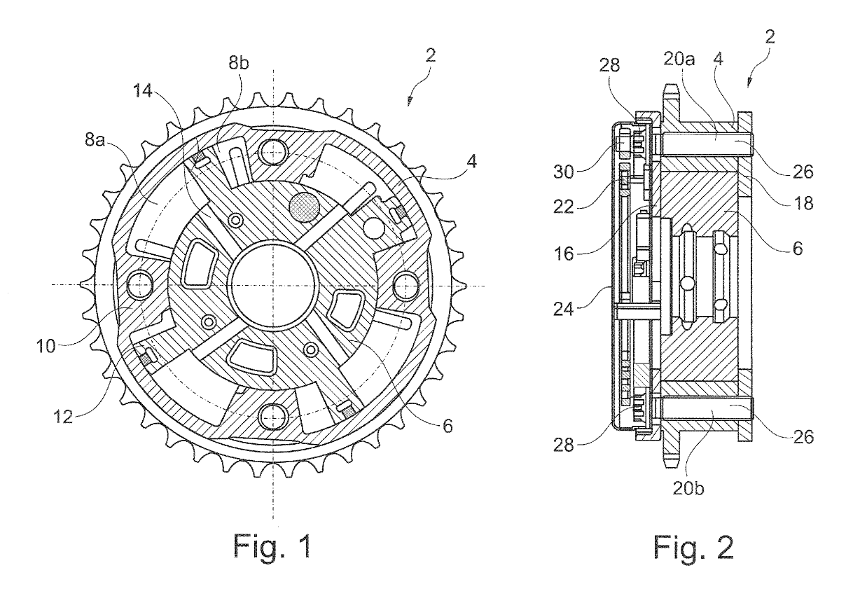

FIG. 1 shows a camshaft adjuster 2 for variably setting the control times of gas valves of an internal combustion engine (not shown further). The camshaft adjuster 2 comprises a drive element 4 which is a stator in this exemplary embodiment, and an output element which is arranged within the stator 4 and is configured as a rotor 6. The rotor 6 is mounted pivotably in relation to the stator 4. A plurality of chamber pairs are formed between the stator 4 and the rotor 6, each chamber pair comprising two pressure chambers 8a, 8b which act in opposite directions with respect to one another. The chamber pairs are separated from one another by webs 10 of the stator 4. A radially extending vane 12 of the rotor 6 separates the two chambers 8a, 8b of a chamber pair which act in opposite directions with respect to one another. A pressure medium, an oil in this case, is fed alternately into the chambers 8a, 8h of a chamber pair. The volume of the respective chamber 8a, 8b is increased by the oil, by the vane 12 being pressed away hydraulically. The volume of the opposing chamber 8a, 8b is reduced correspondingly. The oil is guided alternatingly into one of the chambers 8a, 8h via radial channels 14.

Moreover, the camshaft adjuster 2 has a front side cover 16 and a rear side cover 18. In the exemplary embodiment which is shown, the rear side cover 18 is configured in one piece with the stator 4. The front side cover 16 is connected to the stator 4 by four screws 20a, 20b, of which only two can be seen in FIG. 2.

The camshaft adjuster 2 according to FIG. 2 has a restoring spring 22. In the exemplary embodiment which is shown, the restoring spring 22 is a helical spring. The restoring spring 22 equalizes the force which is required to advance the rotor 6 in relation to the stator 4 in comparison with the force which is required to retain the position of the rotor 6 in relation to the stator 4. The restoring spring 22 is arranged between the rotor 6 and a cover 24. The restoring spring 22 is clipped on two of the four screws 20a, 20b.

In order to clip in the restoring spring 22, two first screws 20a are provided, of which one is shown in the upper region of FIG. 2. The first screw 20a is configured in three pieces and has a threaded section 26, an action section 28 and a fastening section 30. The length of the threaded section 26 corresponds substantially to the width of the rotor 6, and the free end of the threaded section 26 is aligned with the rear side cover 18 on the rear side of the camshaft adjuster 2. In the exemplary embodiment which is shown, the threaded section 26 is approximately 18 mm long. Embodiments of the camshaft adjuster 2 are also possible in which the width of the rotor 6 is greater than the threaded section of the screws 20a, 20b, since the rear side cover 18 is an integral constituent part of the stator 4 and screwing onto the stator is not required.

The action section 28 of the screw 20a is configured as an outer drive. In the exemplary embodiment which is shown, the outer drive has the shape of a hexagonal star. The action section 28 is arranged between the threaded section 26 and the fastening section 30.

The fastening section 30 is configured in the manner of a pin which protrudes axially beyond the action section 28. The cross section of the fastening section 30 is smaller than that of the action section 28, with the result that satisfactory access to the action section 28 with a wrench is ensured axially from the front. In the exemplary embodiment which is shown, the fastening section 30 is configured in one piece with the action section 28 and the threaded section 26. However, it is also conceivable to configure the screw 20a without the fastening section 30, with the result that it corresponds to the second screw 20h in the lower region of FIG. 2, the fastening section 30 being connected to the action section 28 in a separate production step.

In the exemplary embodiment which is shown, the second screw 20b serves merely to fix the front side cover 16 on the stator 4 and therefore does not have a fastening section 30, but rather comprises merely the threaded section 26 and the action section 28. The threaded section 26 and the action section 28 are identical to those of the first screw 20a. This makes it possible that both types of screws 20a, 20b are screwed in with only one assembly tool. Since the action section 28 of the screws 20a, 20b and the fastening section 30 are situated in front of the front side cover 16, first of all the screws 20a, 20b are screwed in and the restoring spring 22 is clipped in the following production step, without it being necessary for the camshaft adjuster 2 to be turned.

With regard to the shape of its drive in combination with the projecting fastening section, the screw 20a represents a novel clipping variation of the restoring spring 22 on the camshaft adjuster 2. The screws 20a, 20b are used universally in conjunction with the cup-shaped stator 4, independently of the width of the camshaft adjuster 2. This screw connection has reduced the stock levels, since the wide variety of screws and therefore the stock items are reduced by the universal use of the screws 20a, 20b. The risk of mistaking them for similar screws is minimal. In addition, the assembly costs are reduced, since the turning of the camshaft adjuster 2 during its assembly is omitted.

### LIST OF DESIGNATIONS

2 Camshaft Adjuster
4 Stator
6 Rotor
8a, 8b Chambers
10 Web
12 Vane
14 Channel
16 Front Side Cover
18 Rear Side Cover
20a First Screw
20b Second Screw
22 Spring Element
24 Covering
26 Threaded Section
28 Action Section
30 Fastening Section

1-9. (canceled)

10. An apparatus for variably setting the control times of gas exchange valves of an internal combustion engine having a crankshaft and a camshaft, the apparatus comprising:
a drive element which can be brought into drive connection with the crankshaft of the internal combustion engine;
an output element, which can be brought into drive connection with the camshaft of the internal combustion engine, pivotable mounted in the drive element;
at least one first screw having a threaded section, an action section engageable by an assembly tool and a fastening section arranged on a side of the action section facing away from the threaded section;
at least one front side cover arranged on an axial front side of the drive element and connected fixedly to the drive element so as to rotate with the drive element by means of the first screw; and
a spring element arranged axially outside of the front side cover and acting on the fastening section of the first screw.

11. The apparatus according to claim 10, further comprising at least one second screw having only a threaded section and an action section.

12. The apparatus according to claim 10, wherein the fastening section is configured in one piece with the action section.

13. The apparatus according to claim 10, wherein the fastening section is configured separately from the action section and the fastening section is fastened to the action section.

14. The apparatus according to claim 10, wherein the action section protrudes beyond the fastening section in a radial direction of the first screw.

15. The apparatus according to claim 10, wherein the action section is star-shaped.

16. The apparatus according to claim 10, further comprising a rear side cover configured in one piece with the drive element.

17. The apparatus according to claim 10, wherein the threaded section is approximately 18 mm long.

18. A screw for fastening a front side cover to an axial front side of a drive element or an output element of an apparatus which variably sets control times of gas exchange valves of an internal combustion engine, comprising:
a threaded section;
an action section engageable with an assembly tool; and
a fastening section arranged on a side of the action section facing away from the threaded section.
